(19) United States
(12) Patent Application Publication
(10) Pub. No.: US 2026/0243592 A1
(43) Pub. Date: Aug. 20, 2026

(54) Method and Device for Determining the Quantity of Fuel in a Pressure Vessel

(71) Applicant: Bayerische Motoren Werke Aktiengesellschaft, Muenchen (DE)

(72) Inventors: Klaas KUNZE, Poing (DE); Andreas PELGER, Ismaning (DE); Alexander ZOTTER, Muenchen (DE)

(21) Appl. No.: 19/480,407

(22) PCT Filed: Apr. 9, 2024
(86) PCT No.: PCT/DE2024/100288

§ 371 Date: Oct. 31, 2025

(30) Foreign Application Priority Data
May 3, 2023 (DE) 10 2023 111 357.7

(51) Int. Cl. G01F 22/02; F17C 13/02

(52) U.S. Cl. CPC G01F 22/02; F17C 13/025; F17C 2205/0326; F17C 2205/0338; F17C 2221/012; F17C 2250/043; F17C 2250/0473; F17C 2265/06; F17C 2270/0168; F17C 2270/0184

(57) ABSTRACT

A device for determining quantity information relating to the quantity of fuel in a pressure vessel of a pressure vessel system is described, where the pressure vessel system is designed to conduct fuel from the pressure vessel via a pressure converter to an energy converter. The pressure vessel system has a low-pressure sensor on a low-pressure side of the pressure converter. The device is configured to determine a measured value for a pressure on the low-pressure side using the low-pressure sensor, and to determine the quantity information relating to the quantity of fuel in the pressure vessel on the basis of the measured value from the low-pressure sensor.

### BACKGROUND AND SUMMARY

The technology disclosed here relates to a method and a corresponding device which are directed to determining the quantity of fuel in a pressure vessel, in particular in order to predict the range of a vehicle based thereon.

A road motor vehicle can have a fuel-cell stack which generates electrical energy for the operation, in particular for the drive, of the vehicle on the basis of a fuel, such as hydrogen. The fuel can be stored in one or more pressure vessels of a pressure vessel system of the vehicle and can be supplied as needed via lines to the fuel-cell stack.

The pressure vessel system typically comprises a pressure sensor which is designed to capture measured values with respect to the fuel pressure in the pressure vessel system. The quantity of fuel in the one or more pressure vessels of the pressure vessel system can be determined on the basis of the measured values, and the remaining range of the vehicle can be predicted on the basis of the determined fuel quantity.

The one or more pressure vessels of the pressure vessel system and the pressure sensor can each be designed for a rated pressure of 350 barg or greater, or 700 barg or greater. The measurement error of a pressure sensor is typically proportional to the rated pressure for which the pressure sensor is designed (for example, 1-2% of the rated pressure or the full-scale pressure). The measured value of the pressure sensor can therefore have a measurement error of 10-20 bar. In a situation having a relatively low fuel pressure and having a relatively low fuel quantity, this can have the result that the remaining quantity of fuel in the pressure vessel and as a result thereof the remaining range of the vehicle can be determined with only relatively low accuracy.

It is a preferred object of the technology disclosed here to reduce or eliminate at least one disadvantage of a previously known solution or to propose an alternative solution. It is a preferred object of the technology disclosed here to enable efficient and precise determination of the fuel quantity in a pressure vessel of a pressure vessel system.

The object(s) is/are achieved by the subject matter of the independent claims. The dependent claims represent preferred embodiments.

According to one aspect, a device for determining quantity information with respect to the quantity of fuel in a pressure vessel of a pressure vessel system is described. Alternatively or additionally, the device can be designed to determine the fuel pressure in the pressure vessel, which can then be used to determine the quantity information (for example, on the basis of a predefined model). The quantity information can be used to determine or estimate the range of a vehicle which is operated using fuel from the pressure vessel.

The pressure vessel system can comprise one or more pressure vessels for storing the fuel (in particular hydrogen, such as H₂, or compressed natural gas (CNG)). The pressure vessel system can be part of a higher-order system (such as a vehicle). The higher-order system can comprise an energy converter configured to generate electrical energy for the operation of the higher-order system on the basis of fuel from the pressure vessel system. In one preferred example, the higher-order system is a motor vehicle (such as a passenger vehicle, a truck, a motorcycle, a bus, etc.).

The pressure vessel system can be used in particular for storing fuel which is gaseous under ambient conditions. The pressure vessel system can be used, for example, in a motor vehicle which is operated using compressed (also called compressed natural gas or CNG) or liquefied (also called liquid natural gas or LNG) natural gas or using hydrogen (in particular H₂) as the fuel. The pressure vessel system is typically fluidically connected to at least one energy converter configured to convert chemical energy of the fuel into one or more other forms of energy. The energy converter can comprise a fuel cell or a fuel-cell stack.

The pressure vessel system typically comprises at least one pressure vessel, in particular a composite overwrapped pressure vessel. The pressure vessel can be, for example, a cryogenic pressure vessel or a high-pressure gas vessel.

High-pressure gas vessels are designed, at ambient temperatures, to permanently store fuel at a nominal operating pressure (also called nominal working pressure or NWP) of at least 350 barg (=elevated pressure in relation to the atmospheric pressure) or at least 700 barg. A cryogenic pressure vessel is capable of storing the fuel at the above-mentioned operating pressures even at temperatures which are significantly (for example, more than 50 K or more than 100 K) below the operating temperature of the motor vehicle.

The pressure vessel system comprises, for example, a line which is designed to conduct fuel from the pressure vessel via a pressure converter (in particular via a pressure regulator) to an energy converter. The energy converter can be configured to convert chemical energy of the fuel into one or more other forms of energy, for example, into electrical energy and/or into kinetic energy. The energy converter can be, for example, an internal combustion engine or fuel-cell system or a fuel-cell stack having at least one fuel cell.

The pressure converter can be designed to reduce the pressure of fuel. A high-pressure side can be arranged at the inlet of the pressure converter (between the pressure vessel and the pressure converter), which is designed for the relatively high fuel pressure of the pressure vessel.

The pressure converter can have one or more converter stages in order to reduce the fuel pressure. A low-pressure side can be arranged here in each case at the outlet of the one or more converter stages which are each designed for a fuel pressure that is lower than the possible pressure (i.e. the rated pressure) on the high-pressure side. The low-pressure side can therefore be arranged at the outlet of the first converter stage or at the outlet of the second converter stage. In particular, the low-pressure side can be arranged at a side of a converter stage of the pressure converter which faces away from the high-pressure side.

The pressure converter, in particular a converter stage of the pressure converter, can be designed to set the fuel pressure to a specific setpoint pressure at the outlet of the pressure converter (in particular at the outlet of the converter stage), in particular by opening and closing a valve and/or by varying the degree of opening of the valve. For example, the degree of opening of the valve of the pressure converter can be varied continuously between 0% and 100%. The degree of opening can be increased when the actual pressure (i.e. the actual value of the pressure) at the outlet of the pressure converter is less than the setpoint pressure. On the other hand, the degree of opening can be reduced when the actual pressure at the outlet of the pressure converter is less than the setpoint pressure. The setpoint pressure can be less here, in particular less by a factor of 2 or more, than the rated pressure of the pressure vessel (for which the high-pressure side is designed).

The pressure vessel system has a low-pressure sensor on the low-pressure side of the pressure converter (i.e. on the side of the pressure converter facing away from the high-pressure side and/or from the pressure vessel). The low-pressure sensor can be designed for the setpoint pressure of the low-pressure side.

Furthermore, the pressure vessel system can have a high-pressure sensor on the high-pressure side (between the pressure vessel and the inlet of the pressure converter). The high-pressure sensor can be designed for the rated pressure of the pressure vessel.

The device is configured to determine a measured value for the pressure on the low-pressure side by way of the low-pressure sensor. The measured value can be captured at a specific measurement time, wherein one or more measurement conditions can be met at the measurement time.

The device is furthermore configured to determine the quantity information with respect to the quantity of fuel in the pressure vessel on the basis of the measured value of the low-pressure sensor.

Therefore, a low-pressure sensor (having a relatively low absolute measurement error) can be used in order to determine the pressure in the pressure vessel. Based on the pressure in the pressure vessel, the fuel quantity in the pressure vessel can be determined. The fuel quantity can thus be determined in an efficient and precise manner.

The device can be configured to detect a measurement time at which the pressure on the high-pressure side (between the pressure vessel and the pressure converter) corresponds to the pressure on the low-pressure side. For this purpose, the duration can be determined since the valve of the pressure converter between the high-pressure side and the low-pressure side (which couples the high-pressure side to the low-pressure side or decouples it therefrom) is permanently (completely) open.

Alternatively or additionally, measured values of the low-pressure sensor can be repeatedly determined. Furthermore, it can be checked whether the individual measured values are above or below the setpoint pressure for the low-pressure side. The duration can then be determined for which the measured values of the low-pressure sensor are below the setpoint pressure in an unchanging manner (and it can therefore be presumed that the valve of the pressure converter is completely open).

It can then be determined on the basis of the determined duration that the pressure on the high-pressure side corresponds to the pressure on the low-pressure side (and therefore a measurement time is present). Alternatively or additionally, the chronological progression of the measured values of the low-pressure sensor with open valve of the pressure converter can be analyzed to recognize that the pressure on the high-pressure side corresponds to the pressure on the low-pressure side.

The measured value of the low-pressure sensor can then be determined or captured at the detected measurement time and used for the determination of the quantity information. The quantity information can thus be determined in a particularly precise manner.

The device can be configured, for an equalization period of time,
to cause the valve of the pressure vessel to be closed, so that no fuel reaches the high-pressure side (of the line) from the pressure vessel; and
to cause fuel from the low-pressure side (of the line) to be consumed by the energy converter.

This operation can be caused until the measurement time is detected at which the pressure on the high-pressure side corresponds to the pressure on the low-pressure side.

An equalization between the pressure on the high-pressure side and the pressure on the low-pressure side can therefore be caused (in a dedicated manner) during the operation of the pressure vessel system. The measurement condition for capturing the measured value of the low-pressure sensor can thus be met in a particularly flexible manner.

The device can be configured to determine an offset value for correcting measurement errors of the high-pressure sensor on the basis of the measured value of the low-pressure sensor determined at the measurement time (wherein the high-pressure sensor is arranged on the high-pressure side between the pressure vessel and the pressure converter). The device can be configured in particular to determine a measured value of the high-pressure sensor at the measurement time. The offset value can then be determined in a particularly precise manner by comparing the measured values of the low-pressure sensor and the high-pressure sensor at the measurement time.

The device can furthermore be configured to determine a measured value of the high-pressure sensor at an operating time during the operation of the pressure vessel system, wherein the operating time can differ from the measurement time. The quantity information with respect to the quantity of fuel in the pressure vessel at the operating time can then be determined in a particularly precise manner on the basis of the measured value of the high-pressure sensor and on the basis of the offset value.

The measured value of the low-pressure sensor (at the measurement time) can therefore be used to determine an offset value by which the absolute measurement error of the high-pressure sensor can be reduced. The amount information can thus be determined in a particularly precise manner.

The device can be configured to determine operating data with respect to an operating condition, in particular with respect to the temperature, of the pressure vessel system, in particular the fuel in the pressure vessel system, at the operating time and at the measurement time. The operating condition can comprise a temperature at the high-pressure sensor and/or at the low-pressure sensor. For example, the offset value can have been determined with a first operating condition (for example, with a first temperature). A second operating condition (possibly deviating therefrom) (for example, a second temperature) can be present at the operating time.

It can be determined on the basis of the operating data whether the offset value determined for the (first) operating condition at the measurement time can be used at the operating time to determine the quantity information (for example, if the first and the second operating condition deviate from one another by less than a predefined threshold value). Alternatively or additionally, it can be determined on the basis of the operating data whether a new offset value is to be determined for the determination of the quantity information (for example, if the first and the second operating condition deviate from one another by more than the predefined threshold value). A particularly precise determination of the quantity information can thus be effectuated.

An offset value can possibly be determined for each of a plurality of different operating conditions. Characteristic data can therefore be determined and stored which indicate the offset value to be used in each case for a plurality of different operating conditions. The offset value to be used for the currently existing operating condition can then be selected from the characteristic data at the operating time. A particularly precise determination of the quantity information can thus be effectuated.

The device can be configured to identify or detect repeatedly measurement times at which an offset value can be determined. The offset value can then be updated repeatedly (possibly in each case for the respective existing operating condition). For the determination of the quantity information at an operating time, the respective most current offset value (for the respective existing operating condition) can then be used. A particularly precise determination of the quantity information can thus be effectuated.

The pressure converter can comprise a first converter stage which is configured to set the pressure at the outlet of the first converter stage to a first setpoint pressure, wherein the first setpoint pressure is lower, in particular by a factor of 2 or more lower, than the rated pressure of the pressure vessel. Furthermore, the first setpoint pressure can be higher, in particular higher by a factor of 2 or more, than the required minimum pressure of the pressure vessel (which is not supposed to be fallen below during the operation of the pressure vessel system).

The pressure converter can furthermore comprise a second converter stage which is configured to set the pressure at the outlet of the second converter stage to a second setpoint pressure. The second setpoint pressure is to be lower here than the first setpoint pressure.

The low-pressure sensor can be arranged between the first converter stage and the second converter stage. The quantity information can thus be determined in a particularly robust and flexible manner. In particular, the measurement condition for capturing the measured value of the low-pressure sensor can thus be met reliably.

The device can be configured to determine a temporal progression of measured values of the low-pressure sensor during the operation of the pressure vessel system (for example, at a measuring rate of 0.1 Hz or more, or of 1 Hz or more). The temporal progression can comprise measured values of the low-pressure sensor for at least one open phase, in which the valve of the pressure converter is open, in order to connect the high-pressure side to the low-pressure side (of the line). An open phase can be, for example, a phase in which the valve of the pressure converter has a degree of opening which is greater than a degree of opening threshold value. The degree of opening threshold value can be, for example, 50% or more.

The quantity information with respect to the quantity of fuel in the pressure vessel can then be determined in a particularly precise manner on the basis of the temporal progression of the measured values of the low-pressure sensor, in particular on the basis of the measured values for the open phase.

According to a further aspect, a pressure vessel system is described, in particular for a motor vehicle. The pressure vessel system comprises the device described in this document.

According to a further aspect, a (road) motor vehicle (in particular a passenger vehicle or a truck or a bus or a motorcycle) is described, which comprises the pressure vessel system described in this document and/or the device described in this document.

According to a further aspect, a method for determining quantity information with respect to the quantity of fuel in a pressure vessel of a pressure vessel system is described, wherein the pressure vessel system is designed to conduct fuel (for example, via a line) from the pressure vessel (which is arranged on the high-pressure side) via a pressure converter to an energy converter (for example, to a fuel cell). The pressure vessel system has a low-pressure sensor on the low-pressure side of the pressure converter (which is arranged, for example, at an outlet of a converter stage of the pressure converter).

The method comprises determining, on the basis of the low-pressure sensor, a measured value for the (fuel) pressure on the low-pressure side. Furthermore, the method comprises determining the quantity information with respect to the quantity of fuel in the pressure vessel on the basis of the measured value of the low-pressure sensor.

According to a further aspect, a software (SW) program is described. The SW program can be configured to be executed on a processor and to thus carry out the method described in this document.

According to further aspect, a storage medium is described. The storage medium can comprise an SW program, which is configured to be executed on a processor and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention is described in more detail hereinafter on the basis of exemplary embodiments.

### BRIEF DESCRIPTION OF THE DRAWINGS

In the figures:

FIG. 1 shows an exemplary pressure vessel system;

FIG. 2 shows an exemplary multistage pressure regulator; and

FIG. 3 shows a flow chart of an exemplary method for determining quantity information with respect to the quantity of fuel in a pressure vessel.

### DETAILED DESCRIPTION OF THE DRAWINGS

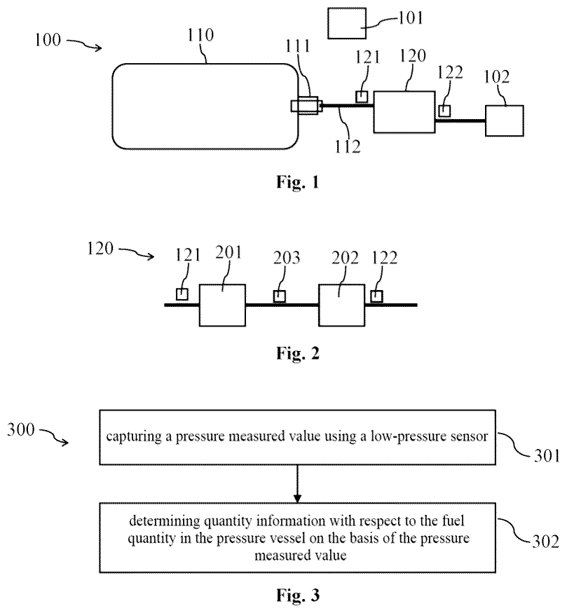

As described at the outset, the present document relates to the efficient and precise determination of the quantity of fuel in a pressure vessel of a pressure vessel system. In this context, FIG. 1 shows an exemplary pressure vessel system 100 having a pressure vessel 110, which can be used to provide fuel (in particular hydrogen, such as H₂) for an energy converter (for example, for a fuel cell or for a fuel-cell stack) 102. The pressure vessel 110 is connected via a line 112 to the energy converter 102. The pressure vessel 110 can have a valve 111, via which fuel can be guided from the pressure vessel 110 into the line 112 in a selective manner.

The fuel pressure in the pressure vessel 110 can be relatively high, in particular at 500 barg or more, in order to be able to accommodate the largest possible quantity of fuel in the pressure vessel 110. On the other hand, the energy converter 102 can be operated using fuel which has a relatively low pressure (for example, 20 barg or less). The fuel line 112 between the pressure vessel 110 and the energy converter 102 can therefore have a high-pressure side and a low-pressure side which are connected to one another via a pressure converter 120.

The fuel pressure on the high-pressure side (between the pressure vessel 110 and the pressure converter 120) can be detected by a high-pressure sensor 121, and the fuel pressure on the low-pressure side (between the pressure converter 120 and the energy converter 102) can be detected by a low-pressure sensor 122. The high-pressure sensor 121 is designed at least for the rated pressure of the pressure vessel 110, for example, for 500 barg or more or for 800 barg or more. The low-pressure sensor 122 is designed for the rated pressure of the energy converter 102, for example, for 30 barg or less. As described at the outset, a pressure sensor 121, 122 typically has a measurement error which is proportional to the rated pressure of the pressure sensor 121, 122. As a result thereof, the low-pressure sensor 122 typically has a significantly smaller (absolute) measurement error than the high-pressure sensor 121 (for example, an (absolute) measurement error which is smaller by a factor of 10 or more).

The pressure vessel system 100 can have a (control) device 101, which is designed to actuate the valve 111 of the pressure vessel 110 and/or to capture or determine measured values of the pressure sensors 121, 122. Furthermore, the device 101 can be designed to determine quantity information with respect to the quantity of fuel in the pressure vessel 110 on the basis of the measured values of one or more pressure sensors 121, 122. The device 101 can use predefined characteristic data and/or a predefined (possibly analytical) characteristic formula for this purpose, which enable the fuel quantity in the pressure vessel 110 to be determined on the basis of the fuel pressure in the pressure vessel 110 (and possibly on the basis of one or more further measured variables such as the fuel temperature).

The device 101 can be configured to take into consideration one or more measured values of the low-pressure sensor 122 in the determination of the quantity of fuel in the pressure vessel 110, in particular in a situation in which the pressure vessel 110 has a relatively low pressure. The accuracy of the determined quantity information can thus be increased, in particular in a situation in which the pressure vessel 110 only still has a relatively small quantity of fuel.

The pressure converter 120 can be designed to regulate the pressure on the low-pressure side to a specific setpoint value or setpoint pressure. A valve of the pressure converter 120 can be opened or closed for this purpose (in particular completely opened or completely closed). In this case, the degree of opening of the valve of the pressure converter 120 can possibly be (continuously) varied. By opening the valve, fuel flows from the high-pressure side to the low-pressure side, by which the pressure on the low-pressure side is increased. The volume or mass flow of fuel via the valve of the pressure converter 120 is typically dependent here on the pressure on the high-pressure side and/or on the pressure difference between the high-pressure side and the low-pressure side.

If the pressure on the low-pressure side sinks below a specific lower pressure threshold value (which is typically lower than the pressure setpoint value or the setpoint pressure for the low-pressure side), the valve of the pressure converter 120 is open and/or the degree of opening of the valve of the pressure converter 120 can be increased, so that (more) fuel flows from the high-pressure side via the pressure converter 120 to the low-pressure side, which results in a pressure increase on the low-pressure side and (typically) a pressure reduction on the high-pressure side. When the pressure on the low-pressure side rises above a specific upper pressure threshold value (which is typically higher than the pressure setpoint value or the setpoint pressure for the low-pressure side), the valve of the pressure converter 120 is closed and/or the degree of opening of the valve of the pressure converter 120 is reduced, which results in a reduction of the fuel quantity that flows from the high-pressure side via the pressure converter 120 to the low-pressure side.

In a corresponding manner, the pressure on the low-pressure side can be set, in particular regulated, to the pressure setpoint value or to the setpoint pressure by varying the degree of opening of the valve of the pressure converter 120. The pressure on the high-pressure side typically sinks in this case and gradually approaches the pressure of the low-pressure side. From a specific time, the pressures on the high-pressure side and on the low-pressure side are equal, which typically has the result that the valve of the pressure converter 120 is permanently (completely) opened (with a degree of opening of 100%).

When the valve of the pressure converter 120 is permanently (completely) open and/or when the pressures on the hydrogen pressure side and on the low-pressure side are equal, the measured values of the low-pressure sensor 122 can be used to determine the remaining quantity of fuel in the pressure vessel 110 with increased accuracy (in comparison to the measured values of the high-pressure sensor 121).

In particular, in such a situation, a measured value of the low-pressure sensor 121 and a measured value of the high-pressure sensor 122 can be compared to one another in order to determine an offset value for the correction of the measured values of the high-pressure sensor 122. The offset value can indicate the (typically systematic) measurement error of the high-pressure sensor 122. If x1 is the measured value of the low-pressure sensor 122 and if the maximum possible (absolute) measurement error of the low-pressure sensor 122 is Δ1, it can be concluded therefrom that the actual value of the pressure is in the value interval [x1−Δ1, x1−Δ1]. If x2 is the measured value of the high-pressure sensor 121 and if the maximum possible (absolute) measurement error of the high-pressure sensor 121 is Δ2, the actual value of the pressure is thus in the value interval [x2−Δ2, x2−Δ2].

The offset value for the correction of measured values of the high-pressure sensor 121 can be determined on the basis of a comparison of the value interval [x1−Δ1, x1−Δ1] with the value interval [x2−Δ2, x2−Δ2]. A computing rule (determined beforehand) can be used for this purpose.

To be able to determine the offset value even if the pressure in the pressure vessel 110 is (possibly significantly) higher than the pressure setpoint value for the low-pressure side, an operating situation can be caused during the operation of the pressure vessel system 100 in which the valve 111 of the pressure vessel 110 is closed in order to be able to equalize the pressure on the high-pressure side to the pressure on the low-pressure side by opening the valve of the pressure converter 120. As soon as the pressures are equalized, an offset value for the measured values of the high-pressure sensor 121 can be determined on the basis of the measured value of the low-pressure sensor 122. The offset value can be stored in a storage unit of the pressure vessel system 100, and can be used to correct the measured values of the high-pressure sensor 121, in order to be able to determine the quantity information with respect to the fuel quantity in the pressure vessel 110 with increased accuracy based thereon.

The pressure vessel 110 can be designed such that the pressure in the pressure vessel 110 is not to fall below a specific minimum pressure, for example, to avoid an impairment of the pressure vessel 110. The minimum pressure of the pressure vessel 110 can be in the range of the pressure setpoint value for the low-pressure side, which has the result that during the operation of the pressure vessel system 100, a situation in which the pressure of the pressure vessel 110 corresponds to the pressure on the low-voltage side possibly does not exist.

FIG. 2 shows a multistage pressure converter 120, which has a first converter stage 201 (having a first valve) that is designed to cause a pressure adaptation of the high-Attorney pressure side to a first (or intermediate) low-pressure side. Furthermore, in a second converter stage 202 (having a second valve) of the pressure converter 120, a pressure adaptation of the first low-pressure side to a further reduced second low-pressure side can be caused. The first low-pressure side can have, for example, a setpoint pressure which is above the setpoint pressure of the second low-pressure side by a factor of 2 or more, or 3 or more (for example, by a factor between 2 and 5).

The pressure converter 120 can have an (additional) low-pressure sensor 203 on the first low-pressure side. Since the setpoint pressure of the first low-pressure side is typically significantly above the minimum pressure of the pressure vessel 110, a measured value of the (additional) low-pressure sensor 203 can be used in a reliable manner (as described above) to determine the quantity information with respect to the fuel quantity in the pressure vessel 110.

Alternatively or additionally, the device 101 can be configured to use the temporal progression of the measured values of the low-pressure sensor 122 to determine the quantity information with respect to the fuel quantity in the pressure vessel 110. The value of the pressure on the high-pressure side and therefore the fuel quantity can thus be determined in a particularly precise manner.

As described at the outset, in a fuel-cell vehicle (FCEV, fuel-cell electric vehicle), highly compressed gaseous hydrogen is stored in a pressure vessel 110. To increase the energy density, the gaseous hydrogen is compressed to a pressure of up to 875 bar and stored as CGH2 (compressed gaseous hydrogen) in the pressure vessel 110. The storage quantity and, based thereon, the vehicle range can be determined on the basis of a pressure and temperature measurement of the stored gas. A pressure sensor 121 having a measurement range (i.e. having a rated pressure) of up to 900 bar can be used for the pressure measurement. Such a pressure sensor 121 typically has a measurement error of up to 1-2% of the rated pressure (i.e. full-scale) due to the relatively broad media temperature range, due to the tolerances of electronic components, and/or due to mechanical manufacturing tolerances, which corresponds to an absolute measurement error of up to approximately ±20 bar. This measurement error is to be taken into consideration in the vehicle operating strategy, especially in the range calculation and/or in the event of a removal stop due to the status “pressure vessel empty.” The type IV pressure vessel 110 used as the CGH2 storage device can comprise a plastic liner having complete CFRP (carbon fiber-reinforced plastic) reinforcement. Such a pressure vessel 110 possibly requires a minimum pressure, which the pressure is not supposed to fall below in operation, over its service life. The maximum possible measurement error of the high-pressure sensor 121 is to be taken into consideration here in the vehicle operating strategy in order to reliably avoid the pressure falling below the minimum pressure of the pressure vessel 110.

In order to protect the pressure vessel 110 from falling below the minimum pressure, the previously known measurement error can be added as a safeguard to a measured value of the high-pressure sensor 121. This procedure can result in a premature shutdown of the pressure vessel system 100 and a relatively high non-usable quantity (in particular mass) of fuel in the pressure vessel 110. The available fuel quantity in a pressure vessel system 100 and therefore the vehicle range can thus depend on the measurement error of the high-pressure sensor 121 of the pressure vessel system 100.

To increase the usable fuel quantity of the pressure vessel system 100 and therefore the vehicle range, the pressure of the pressure vessel 110 can be detected at a relatively low pressure via a pressure sensor 122, 203 connected downstream of the regulating stage (i.e. of the pressure converter 120) (and possibly not via the high-pressure sensor 121). The outlet pressure (i.e. the regulating pressure) after the regulating stage 120 is typically multiple times below the inlet pressure. Accordingly, after the regulating stage 120, the absolute value of the measurement error and therefore the required reserve, which has a negative effect on the determined vehicle range, are substantially less.

A mechanical piston-spring pressure regulator can be used as the pressure converter 120 or regulating stage 201, 202. Such a pressure converter 120 can be designed such that at an inlet pressure which is less than the regulating pressure (i.e. the setpoint pressure), a pressure equalization automatically takes place between the inlet pressure and the outlet pressure. This enables, at an inlet pressure which is less than or equal to the regulating pressure, an accuracy comparison to be carried out between the measurement positions of the pressure sensors 121, 122 before and after the regulating stage 120. This is supposed to have the effect that the regulating pressure including the consideration of the measurement error of the pressure sensor 122 after the regulating stage 120 is above the minimum pressure of the pressure vessel 110.

The relatively small measurement error reserve of the pressure sensor 122 (i.e. the moderate-pressure or low-pressure sensor) at the outlet of the pressure regulator 120 can thus be used. The measured value of the moderate-pressure sensor 122 can be used here as the removal stop criterion. The measured value of the high-pressure sensor 121 can be used for the range calculation.

In a 2-stage pressure regulating unit 120 (see FIG. 2), the basic behavior of a 2-stage regulator can be used. The first stage 201 regulates the high pressure, for example, to a pressure of approximately 60-70 bar and the second stage 202 regulates it to the required regulating pressure (outlet pressure). By integrating a pressure sensor 203 between the two regulating stages 201, 202 (interstage), a measurement position can be provided for a pressure measurement having a measurement error (reduced in relation to the high-pressure sensor 121). For example, a pressure sensor 203 having a rated pressure of 100 bar can be used in comparison to a rated pressure of 1000 bar, so that the absolute measurement error can be reduced by a factor of 10.

The range calculation at a relatively low pressure within the pressure vessel 110 can take place on the basis of a measured value of the additional pressure sensor 203, without the pressure falling below the minimum pressure of the pressure vessel 110 in this case. Furthermore, a removal stop because of reaching the status: “measured pressure of the additional pressure sensor 203=tank minimum pressure (including error reserve for the measurement error of the pressure sensor interstage 203)” can be deliberately predicted.

Alternatively or additionally, a high-pressure to moderate-pressure sensor 121, 122 equalization function can be provided with closed tank valve of the pressure vessel 110. Such an equalization function can be implemented here for the driving operation or for a standstill of a vehicle. The pressure before the regulating stage 120 can be reduced with closed tank valve below or to the regulating pressure (outlet pressure). The regulating pressure can be the pressure at which the valve of the pressure converter 120 or the converter stage 201, 202 opens. The reduction of the pressure can be caused by a targeted removal via the energy converter 102. The regulating stage 120 is completely open in this state (with a degree of opening of 100%) and the inlet pressure is equal to the outlet pressure.

In this state, the measured value of the moderate-pressure sensor 122 including the maximum measurement error of the moderate-pressure sensor 122 can be used as the physical pressure for the high-pressure sensor 121. Since the measurement error of the high-pressure sensor 121 is a relatively constant offset error, the measurement accuracy in the pressure range 0 -30 bar and the temperature conditions prevailing at this time can be increased to the pressure level of the high-pressure sensor 121 by this equalization.

In order to keep the pressure losses during the sensor equalization low, the dynamics of the removal mass flow can be limited. After the equalization procedure, the tank valve of the pressure vessel 110 can be opened again, and the dynamics restriction can be canceled. The value of the equalized high-pressure sensor 121 can be used as the range calculation and removal stop criterion. In addition, the value of the moderate-pressure or low-pressure sensor 122 can be used as a plausibility check. If the conditions ambient temperature and/or media temperature also change significantly during the equalization procedure, the equalization procedure can be repeated.

FIG. 3 shows a flow chart of a (possibly computer-implemented) method 300 for determining quantity information with respect to the quantity of fuel in a pressure vessel 110 of a pressure vessel system 100. The pressure vessel system 100 comprises a line 112, which is designed to conduct fuel from the pressure vessel 110 via a pressure converter 120 (in particular a pressure regulator) to an energy converter 102 (in particular to a fuel-cell stack). Furthermore, the pressure vessel system 100 comprises a low-pressure sensor 122, 203 on the low-pressure side between the pressure converter 120 (in particular between a converter stage 201 of the pressure converter 120) and the energy converter 102. Moreover, the pressure vessel system 100 can have a high-pressure sensor 121 on the high-pressure side between the pressure vessel 110 and the pressure converter 120. The low-pressure sensor 122, 203 has a rated pressure which corresponds, for example, to the setpoint pressure of the pressure converter 120. The high-pressure sensor 121 can have a rated pressure which corresponds to the rated pressure (for example, the maximum possible pressure) of the pressure vessel 110.

The method 300 comprises determining 301, on the basis of the low-pressure sensor 122, 203, a measured value for the pressure on the low-pressure side. The measured value can be determined at a measurement time at which one or more measurement conditions are met. One exemplary measurement condition is that at the measurement time, the pressure on the high-pressure side corresponds to the pressure on the low-pressure side of the pressure converter 120.

The method 300 furthermore comprises determining 302 the quantity information with respect to the quantity of fuel in the pressure vessel 110 on the basis of the measured value of the low-pressure sensor 122, 203. A predefined model can be used here, which is designed to determine the quantity of fuel in the pressure vessel 110 on the basis of a value of the pressure in the pressure vessel 110. The quantity information can be used to cause the removal stop of fuel from the pressure vessel 110.

Due to the use of one or more measured values of the low-pressure sensor 122, 203 to determine the pressure in the pressure vessel 110, the pressure in the pressure vessel 110 can be determined with a relatively low measurement error, by which a relatively accurate determination of the fuel quantity is enabled. The remaining range of a vehicle which is operated using the fuel from the pressure vessel 110 can be determined on the basis of the quantity information, for example.

The present invention is not restricted to the exemplary embodiments shown. In particular, it is to be noted that the description and the figures are only to illustrate by way of example the principle of the proposed methods, devices, and systems.

### List of Reference Signs

100 pressure vessel system
101 (control) device
102 energy converter
110 pressure vessel
111 pressure vessel valve
120 pressure converter
121, 122 pressure sensor
201, 202 converter stage (pressure converter)
203 pressure sensor
300 method for determining quantity information
301-302 method steps

1-10. (canceled)

11. A device for determining quantity information with respect to a quantity of fuel in a pressure vessel of a pressure vessel system, wherein the pressure vessel system is designed to conduct fuel from the pressure vessel via a pressure converter to an energy converter, and wherein the pressure vessel system has a low-pressure sensor on a low-pressure side of the pressure converter, wherein the device is configured to determine a measured value for a pressure on the low-pressure side on the basis of the low-pressure sensor; and
to determine the quantity information with respect to the quantity of fuel in the pressure vessel on the basis of the measured value of the low-pressure sensor, and
wherein the pressure converter comprises:
a first converter stage configured to set a pressure at an outlet of the first converter stage to a first setpoint pressure, wherein the first setpoint pressure is lower by a factor of 2 or more than the rated pressure of the pressure vessel, wherein the first setpoint pressure is higher by a factor of 2 or more than a required minimum pressure of the pressure vessel; and
a second converter stage configured to set a pressure at an outlet of the second converter stage to a second setpoint pressure, wherein the second setpoint pressure is less than the first setpoint pressure, wherein the low-pressure sensor is arranged between the first converter stage and the second converter stage.

12. The device according to claim 11, wherein the device is configured
to detect a measurement time at which a pressure on a high-pressure side between the pressure vessel and the pressure converter corresponds to the pressure on the low-pressure side; and
to determine the measured value of the low-pressure sensor at the measurement time and to use it for the determination of the quantity information.

13. The device according to claim 12, wherein the device is configured
to determine a period of time since a valve of the pressure converter between the high-pressure side and the low-pressure side is permanently open, in particular permanently completely open; and
to determine depending on the determined period of time that the pressure on the high-pressure side corresponds to the pressure on the low-pressure side.

14. The device according to claim 12, wherein the device is configured, for an equalization period of time
to cause a valve of the pressure vessel to be closed, so that no fuel from the pressure vessel reaches the high-pressure side; and
to cause fuel from the low-pressure side to be consumed by the energy converter;
until the measurement time is detected at which the pressure on the high-pressure side corresponds to the pressure on the low-pressure side.

15. The device according to claim 11, wherein the device is configured
on the basis of a measured value of the low-pressure sensor determined at a measurement time, to determine an offset value for the correction of measurement errors of a high-pressure sensorarranged on a high-pressure side between the pressure vessel and the pressure converter;
at an operating time during the operation of the pressure vessel system, to determine a measured value of the high-pressure sensor, wherein the operating time differs in particular from the measurement time; and
to determine the quantity information with respect to the quantity of fuel in the pressure vessel at the operating time on the basis of the measured value of the high-pressure sensor and on the basis of the offset value.

16. The device according to claim 15, wherein the device is configured
to determine a measured value of the high-pressure sensor at the measurement time; and
to determine the offset value by comparing the measured values of the low-pressure sensor and the high-pressure sensor at the measurement time.

17. The device according to claim 15, wherein the device is configured
to determine operating data with respect to an operating condition, in particular with respect to a temperature, of the pressure vessel system, in particular the fuel in the pressure vessel system, at the operating time and at the measurement time;
on the basis of the operating data, to determine whether
the offset value determined for the operating condition at the measurement time can be used at the operating time to determine the quantity information; and/or
a new offset value is to be determined for the determination of the quantity information.

18. A method for determining quantity information with respect to a quantity of fuel in a pressure vessel of a pressure vessel system, wherein the pressure vessel system comprises: a pressure converter to conduct fuel from the pressure vessel to an energy converter; and a low pressure sensor on a low-pressure side of the pressure converter, the method comprising:
determining, on the basis of the low-pressure sensor, a measured value for a pressure on the low-pressure side; and
determining the quantity information with respect to the quantity of fuel in the pressure vessel on the basis of the measured value of the low-pressure sensor,
wherein the pressure converter comprises:
a first converter stage configured to set a pressure at an outlet of the first converter stage to a first setpoint pressure, wherein the first setpoint pressure is lower by a factor of 2 or more than the rated pressure of the pressure vessel, wherein the first setpoint pressure is higher by a factor of 2 or more than a required minimum pressure of the pressure vessel; and
a second converter stage configured to set a pressure at an outlet of the second converter stage to a second setpoint pressure, wherein the second setpoint pressure is less than the first setpoint pressure, wherein the low-pressure sensor is arranged between the first converter stage and the second converter stage.

19. The method according to claim 18, further comprising:
detecting a measurement time at which a pressure on a high-pressure side between the pressure vessel and the pressure converter corresponds to the pressure on the low-pressure side; and
determining the measured value of the low-pressure sensor at the measurement time and using it for the determination of the quantity information.

20. The method according to claim 19, further comprising:
determining a period of time since a valve of the pressure converter between the high-pressure side and the low-pressure side is permanently completely open; and
determining depending on the determined period of time that the pressure on the high-pressure side corresponds to the pressure on the low-pressure side.

21. The method according to claim 19, further comprising, for an equalization period of time:
causing a valve of the pressure vessel to be closed so that no fuel from the pressure vessel reaches the high-pressure side; and
causing fuel from the low-pressure side to be consumed by the energy converter;
until the measurement time is detected at which the pressure on the high-pressure side corresponds to the pressure on the low-pressure side.

22. The method according to claim 18, further comprising:
on the basis of a measured value of the low-pressure sensor determined at a measurement time, determining an offset value for correction of measurement errors of a high-pressure sensor arranged on a high-pressure side between the pressure vessel and the pressure converter;
at an operating time during the operation of the pressure vessel system, determining a measured value of the high-pressure sensor, wherein the operating time differs from the measurement time; and
determining the quantity information with respect to the quantity of fuel in the pressure vessel at the operating time on the basis of the measured value of the high-pressure sensor and on the basis of the offset value.

23. The method according to claim 22, further comprising:
determining a measured value of the high-pressure sensor at the measurement time; and
determining the offset value by comparing the measured values of the low-pressure sensor and the high-pressure sensor at the measurement time.

24. The method according to claim 22, further comprising:
determining operating data with respect to an operating condition, in particular with respect to a temperature, of the pressure vessel system, in particular the fuel in the pressure vessel system, at the operating time and at the measurement time; and
on the basis of the operating data, determining whether
the offset value determined for the operating condition at the measurement time can be used at the operating time to determine the quantity information; and/or
a new offset value is to be determined for the determination of the quantity information.
